(19) United States
(12) Patent Application Publication
(10) Pub. No.: US 2007/0107612 A1
(43) Pub. Date: May 17, 2007

(54) Cylinder of a printing press and bearing arrangements for it

(75) Inventor: Godber Petersen, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/600,363

(22) Filed: Nov. 15, 2006

(30) Foreign Application Priority Data
Nov. 16, 2005 (DE) 10 2005 054 477.0

(51) Int. Cl. B41F 5/00

(52) U.S. Cl. 101/216

(57) ABSTRACT

A cylinder assembly for a printing press includes a pair of bearing assemblies mounted in side frames of a printing press, and a cylinder body having a pair of opposed end surfaces with no axle stubs clamped between the bearing assemblies. Each end surface is fixed to a respective bearing arrangement to form a connection, and at least one locking device can be operated from one end of the cylinder body to tighten or release the two connections.

### BACKGROUND OF THE INVENTION

1. Field of the Invention

The invention pertains to a cylinder of a printing press and to bearing arrangements for it, where the bearing arrangements are installed in the side frames of the printing press and are moved toward the cylinder to clamp it or away from the cylinder to release it.

2. Description of the Related Art

Cylinders of printing presses in the form of, for example, form or transfer cylinders usually consist of the cylinder body itself, the so-called “cylinder barrel”, and axle stubs connected to the end walls of the cylinder body. The axle stubs are then supported in the side frames of the printing couple. Because of the way the cylinder is designed, there is a relatively long distance between the bearings, which leads to corresponding bending stress and thus to the deflection of the form cylinder. To compensate as effectively as possible for this bending stress or deflection, the cylinder body must be very sturdy. As a result, these cylinders are often very heavy, expensive, and relatively awkward and difficult to remove.

### SUMMARY OF THE INVENTION

The object of the invention is to improve the cylinders and bearing arrangements of printing presses.

The inventor realized that, with respect to the flexural properties of the cylinders, it is advantageous for the cylinders of a printing press to be designed without axle stubs. To support the cylinder inside the side frames, bearing assemblies with movable shafts are installed in the side frames. The ends of the shafts are moved toward the end walls of the cylinder to clamp it in place and moved away from the cylinder to release it.

According to the invention, in a printing press where the bearing devices are installed in side frames and are moved toward the cylinder to clamp it or away from the cylinder to release it, the cylinder of the printing press and the bearing arrangements for the cylinder are improved by designing the cylinder so that it consists only of the cylinder body and thus has no axle stubs. The cylinder is first clamped between its two end surfaces and then cooperates with the bearing arrangements to form fixed connecting points. At least one locking device is provided, which can be operated from one end of the cylinder to tighten or to release the two connections.

Because the cylinder does not have axle stubs, its clamping length (distance between clamping points) is shorter and thus its deflection can be reduced. Because of its compact design, furthermore, the cylinder can be easily installed and removed in the radial direction relative to the axis of rotation of the cylinder.

The cylinder can consist of a single element or of several elements. In the case of a cylinder with a multi-part design, the cylinder can include a core, onto which various sleeves of various diameters are pushed. The possibility of pushing sleeves of different diameters onto the core of the cylinder means that the (printing) format of the printing press can be changed relatively quickly.

It is advantageous for at least certain parts of the cylinder or for the entire cylinder to consist of a foam material, preferably of metal foam and/or plastic foam. The foam material offers the advantage of an enormous savings in weight, as a result of which deviation torques during the rotation of the cylinder can be almost completely avoided.

In another embodiment of the cylinder, a stiffening shaft can be located at the center of rotation. This stiffening shaft in the interior of the cylinder can have both internal and external threads at the ends, at which the screwed connections to the bearing arrangements are made.

It is also favorable for the cylinder to have a coating in the area of its outer circumferential surface. This coating can have any of various properties. For example, it can serve to reduce the wear on the surface of the cylinder. It is also conceivable, however, that the coating could have heat-conducting or insulating properties.

It is also advantageous for at least one channel to be let into the cylinder in the area of the outer lateral surface. Tempering media such as liquids or gases can be conducted through this channel to keep the cylinder at a desired uniform temperature.

Conical rings and/or conical disks can be embedded in the end walls of the cylinder. The conical rings and/or conical disks can absorb the clamping forces of the bearing arrangements and thus prevent damage to the cylinder during the clamping operation.

To increase the flexural stiffness of the cylinder, it is advantageous to provide stiffening elements in the cylinder in the axial and/or radial direction. The inventive cylinder can be designed as a form cylinder, as a transfer cylinder, or as a satellite cylinder.

As a result of the special design of the cylinder and as a result of the significant reduction in its deflection, the cylinder can be designed with a length of up to approximately 5 meters.

So that the bearing arrangements can be moved toward the cylinder to clamp it and away from the cylinder to release it, it is favorable for the bearing arrangements to have at least one axially adjustable spindle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a side view of a known double printing unit;

FIG. 2 shows a cross section through a cylinder and cylinder bearing arrangement according to the prior art;

FIGS. 3-5 show sections through cylinders and cylinder bearing arrangements for axial and radial installation/removal of the cylinders according to the invention;

FIGS. 6-9 show cross sections through cylinder bodies of various designs; and

FIG. 10 shows an axial cross section of a cylinder body with so-called “minigaps” for printing plates.

### DETAILED DESCRIPTION OF THE PRESENTLY PREFERRED EMBODIMENTS

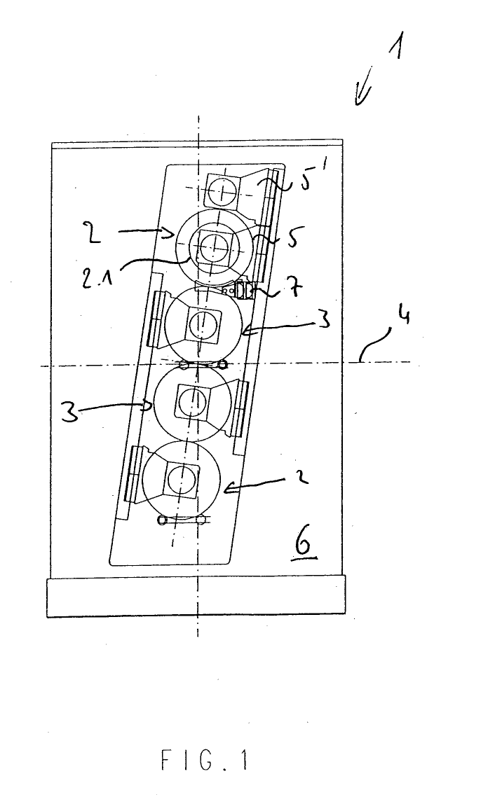

FIG. 1 shows a side view of a double printing unit 1 of a printing press, each with two form cylinders 2, on which the images to be printed are provided, and two transfer cylinders 3, which transfer the images with the help of ink to both sides of the substrate web 4. The cylinder axes or axle stubs of the form and transfer cylinders 2 and 3 are supported in bearing blocks 5, which can be moved in the vertical direction and which are also fastened to the side frames 6 of the printing press. So that the cylinder sleeves 2.1 or the cylinders 2, 3 themselves can be removed, a telescoping arm 7 is used to shift the bearing blocks 5 individually in the vertical direction, as indicated by way of example for the upper form cylinder 2 by the position number 5′ of the bearing block 5.

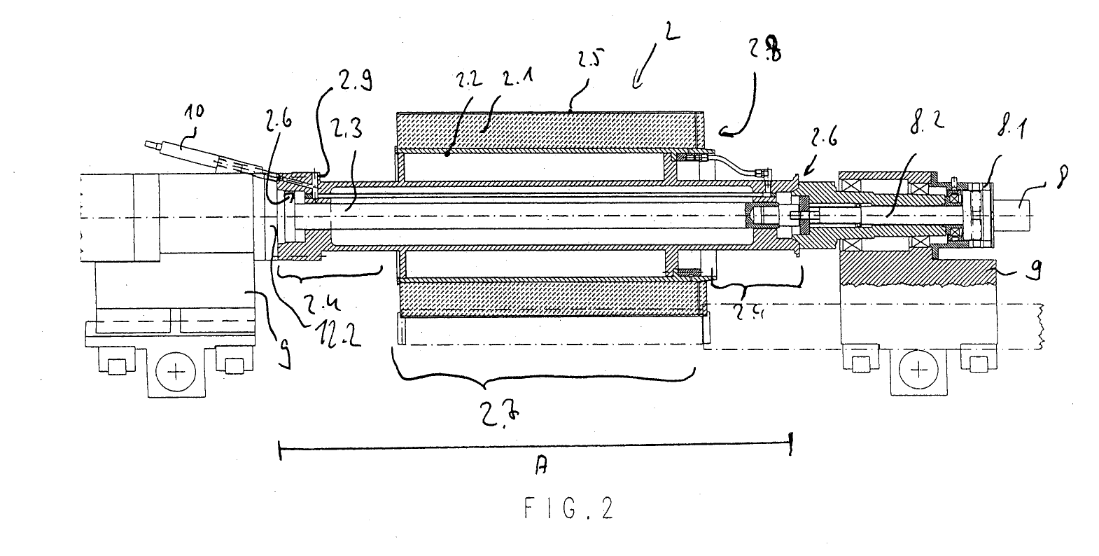

FIG. 2 shows a cross section through a form cylinder 2 and its cylinder bearings according to the state of the art.

The form cylinder 2 has a so-called cylinder core 2.2, which is mounted on an axle journal 2.3 and screwed to a drive spindle 12.2, which is supported in a bearing arrangement 9. The overall length of the form cylinder 2 with the integrated axle stubs 2.4 is designated “A” in FIG. 2. The bearing arrangement 9 is mounted on rails and can move in the horizontal direction. As already described above in connection with FIG. 1, movement on rails in the vertical direction is also possible.

The drive spindle 12.2 of the bearing arrangement 9 is fastened by a screw to the journal 2.3. Thus the axle stubs 2.4 and the cylinder core 2.2 are supported on the left and right on conical surfaces 2.6 and clamped between them by the screwed connection. When the cylinder is being used as a form cylinder, a so-called sleeve 2.5, here a form sleeve, is mounted on the cylinder sleeve 2.1. If the cylinder is being used as a transfer cylinder, a rubber blanket sleeve is mounted on the cylinder sleeve 2.1. If the cylinder sleeve 2.1 is to be removed in the axial direction, a locking/unlocking device 8, here a pneumatic cylinder, is used to activate a locking bar 8.1, which blocks a locking screw 8.2. By using the drive spindle 12.2 to rotate the cylinder core 2.2, the screwed connection can be unscrewed, and the bearing block can then be pushed into position 5′ (see FIG. 1). By means of an air supply arrangement 10 and a distributor ring, an air cushion is produced in the known manner between the cylinder core 2.2 and the cylinder sleeve 2.1, so that the cylinder sleeve 2.1 can be removed in the axial direction by means of, for example, a telescoping arm. Outside the printing couple, it is now possible with the help of air channels and a distributor ring to separate the form sleeve or rubber blanket sleeve 2.5 from the cylinder sleeve 2.1 in the known manner.

When the cylinder 2 is under load, the journal 2.3 of the cylinder core 2.2 itself is subject to deflection as a result of the relatively long distance between the conical surfaces 2.6. To counteract this, the journal 2.3 and the cylinder body 2.7 itself must be very sturdy. As a result, the cylinder 2 becomes relatively heavy and troublesome to construct.

To counteract this circumstance, according to the present invention the conical surfaces 2.6 are shifted to the area of the end walls 2.8 of the cylinder body 2.7.

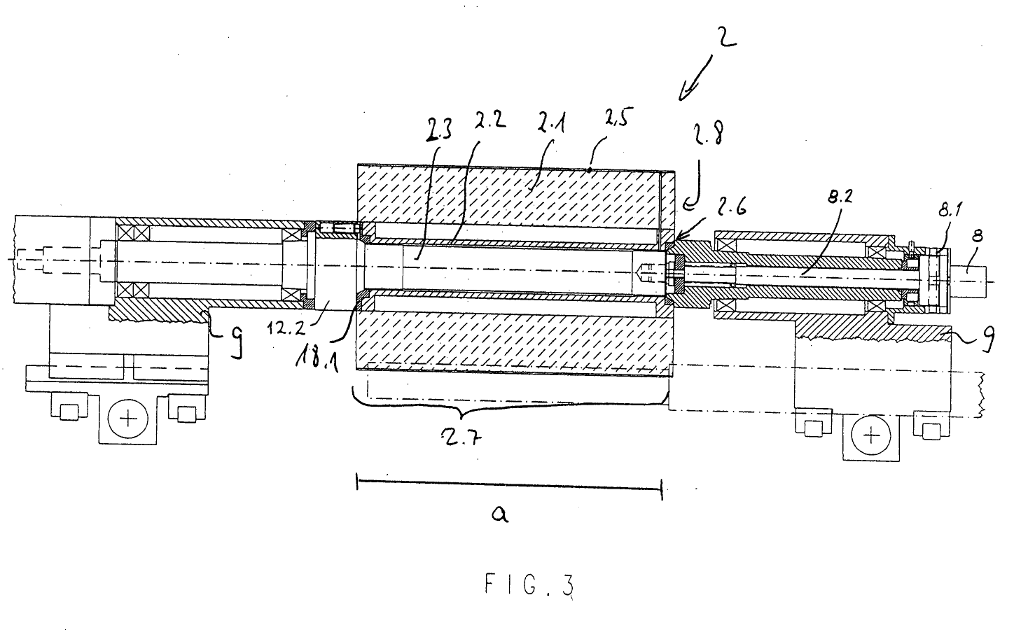

FIGS. 3-5 show cross-sectional views through a according to the invention cylinder, here in the form of a form cylinder 2, and its bearing arrangement. At this point, it should be mentioned that this new cylinder design is suitable for all types of cylinders in printing presses such as form cylinders, transfer cylinders, and/or satellite cylinders.

As a result of the special design of the cylinder, namely, a design without axle stubs, with a total length “a” which is shorter than the total length “A” of the previous form cylinder 2, it becomes much easier both to install and to remove the form cylinder 2 in the axial and the radial directions. In addition, because the conical support surfaces 2.6 are shifted to the area of the end walls 2.8 of the cylinder body or of the cylinder barrel 2.7, the deflection of the form cylinder 2 is significantly reduced. The drive spindle 2.2 and the bearing arrangement 9 are lengthened to make up for the now-absent axle stubs of the form cylinder 2. The journal 2.3 is merged with the drive spindle 2.2 to form a single unit, as are the cylinder core 2.2 and the cylinder sleeve 2.1.

Overall, this arrangement results in a much simpler design, especially for the cylinder body 2.7. It can now consist of a metal core with inserted conical rings 18.1, which can be fabricated cheaply, and of the lightest possible body, such as a body of foamed metal. This body can be covered by a layer of material adapted as appropriate to specific requirements. The layer can be a wear-reducing, a thermally conductive, or an insulating layer. A sleeve 2.5, either a form sleeve or a rubber blanket sleeve, can be pushed onto this layer. This pushing-on of the sleeves 2.5 by the use of air channels and a corresponding adapter is done outside the printing couple after the cylinder body 2.7 has been removed.

As a result of the design described above, the weight of the cylinder body 2.7 is reduced to such an extent that it is practically the same as the weight of the cylinder sleeve 2.1. As a result of this weight reduction, this new cylinder can therefore also be removed in the axial direction by means of a telescoping arm.

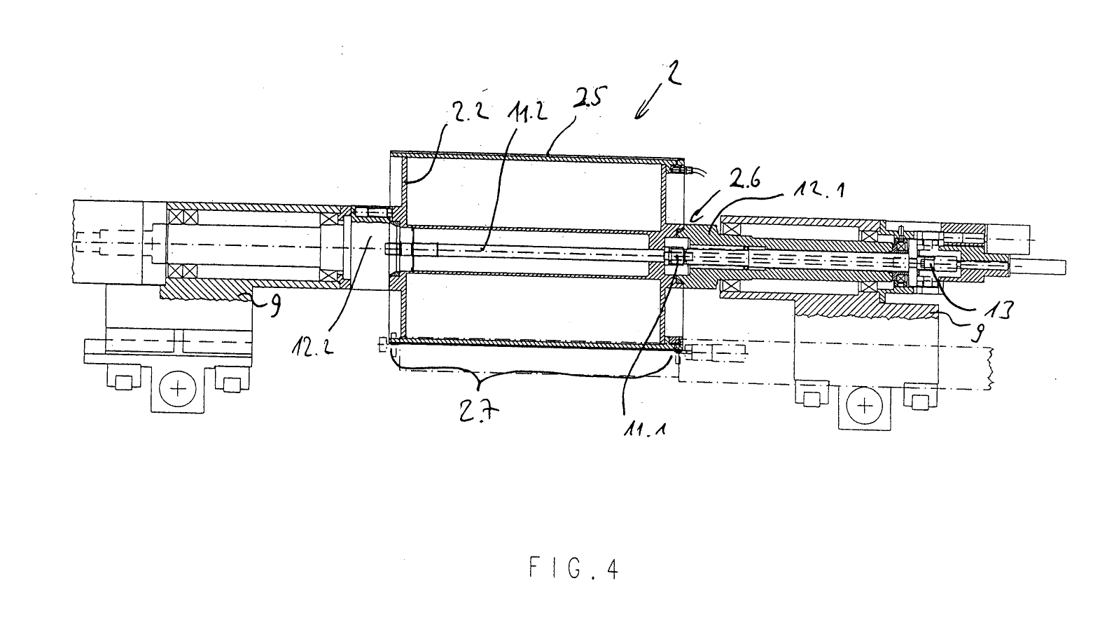

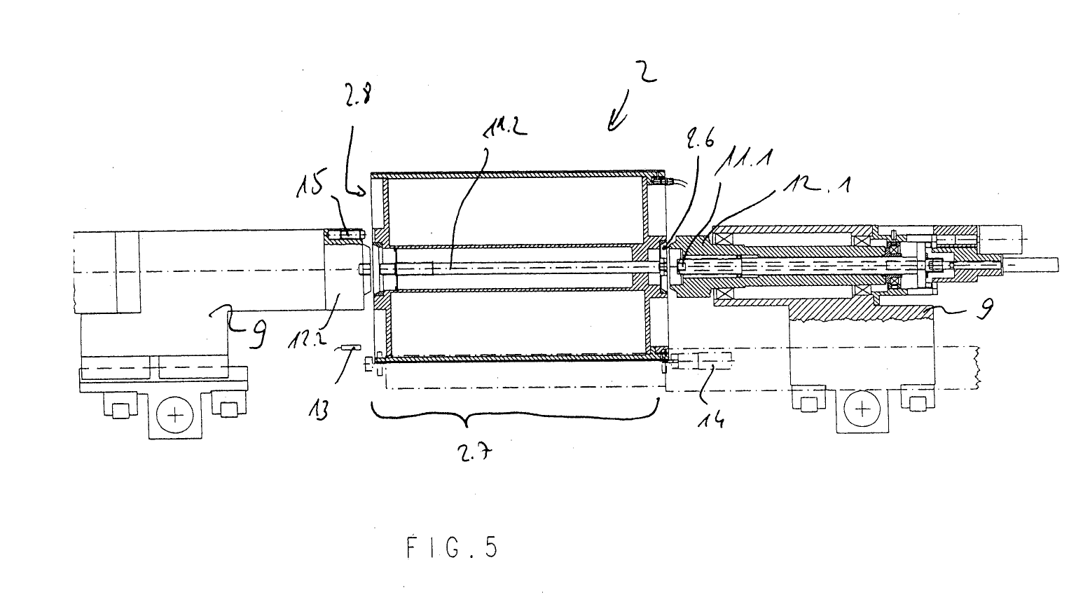

FIGS. 4 and 5 show not only the form cylinder 2 but also the elaborated bearing arrangements 9, so that the cylinder body 2.7 can be removed not only in the axial direction but also in a direction at a 90° angle to the axial direction. The reliable support of the cylinder body 2.7 on the conical surfaces 2.6 is achieved by means of a double screw connection. The cylinder body 2.7 is connected on the right and on the left to spindles 12.1, 12.2 by means of screws 11.1, 11.2. For removal, first the screwed connection between the right spindle 12.1 and the cylinder body 2.7 is unscrewed. For this purpose, a bolt, such as a bolt with an outside hexagon, is pushed forward by a pneumatic cylinder to block the right screw 11.1 of the form cylinder 2. The left spindle 12.2 is now used to rotate the cylinder body 2.7 and thus to unscrew the connection. Then the pneumatic cylinder is used to activate a sleeve, which has a claw by which the left screw 11.2 can also be blocked. By rotating the spindle 12.2 again, the screwed connection between this spindle and the cylinder body 2.7 is also unscrewed. The form cylinder 2 can now be transported to an external location by means of, for example, a hoist.

How the cylinder body 2.7 is reinstalled is explained briefly below on the basis of FIG. 5. The installation process takes place in the order opposite that of the removal process. In FIG. 5, the form cylinder 2 is located between the opened bearing arrangements 9. By means of a sensor 13 and a drive 14, the form cylinder 2 is positioned correctly in the circumferential direction, so that a bolt 15 can engage correctly in the left end wall 2.8 of the form cylinder 2. Then the left screw 11.2 is used to screw the left spindle 12.2 to the cylinder body 2.7, and finally the right screw 11.1 is used to screw the right spindle 12.1 to the cylinder body 2.7. Thus the cylinder body is seated securely again on the conical surfaces 2.6.

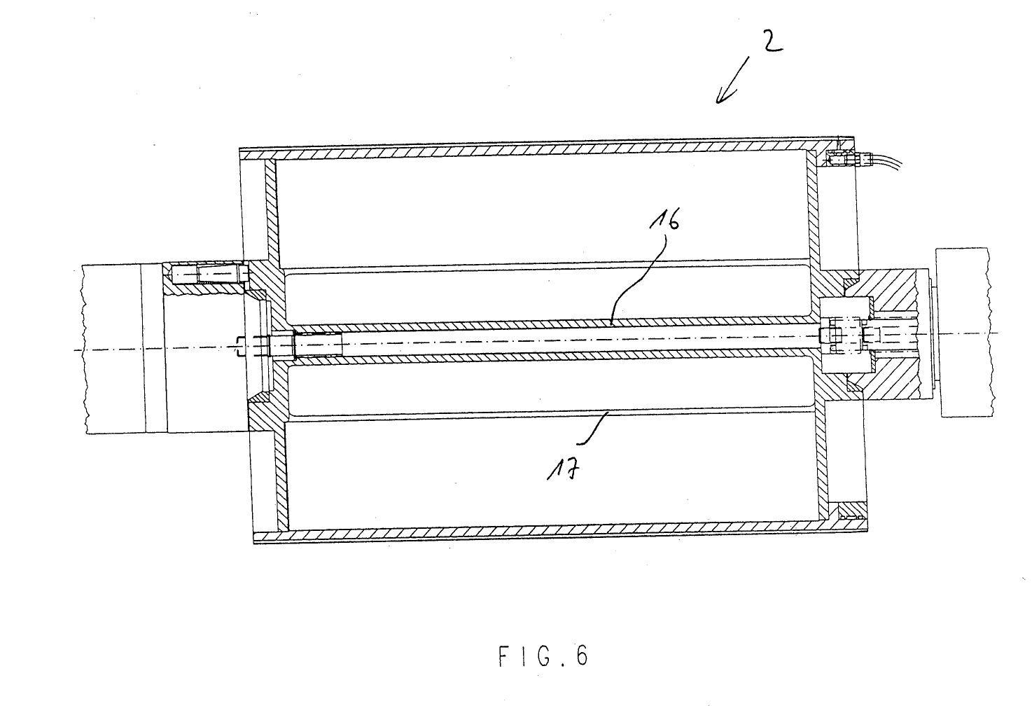

FIG. 6 shows a form cylinder 2 with another possible design. The screwing forces in this design are absorbed centrally by a tube 16, and the bending forces are absorbed by webs 17.

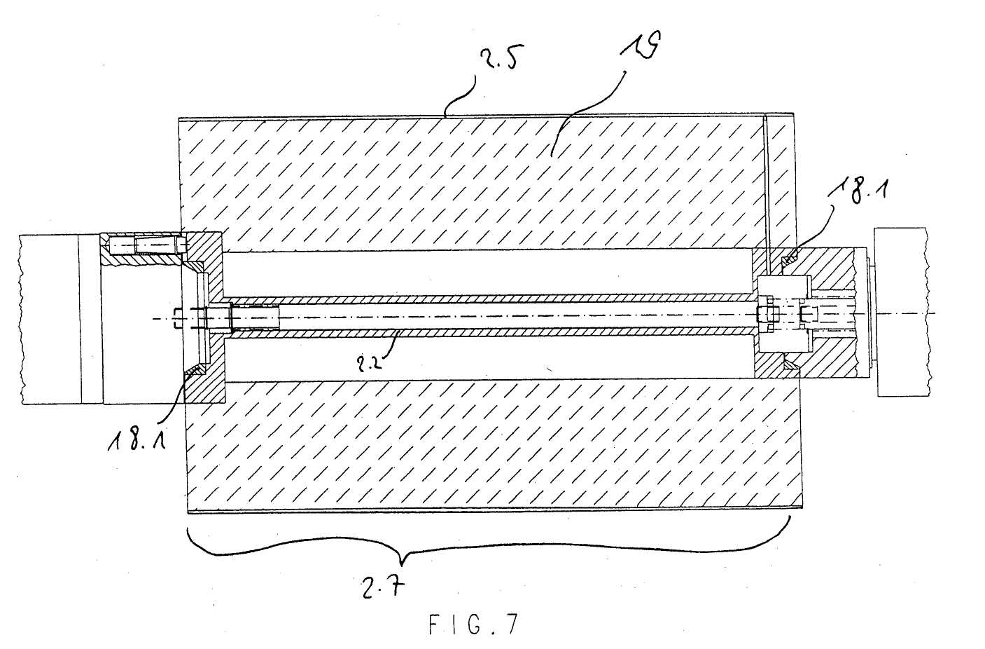

The cylinder body 2.7 according to FIG. 7 also has a cylinder core 2.2 for absorbing the same screw-tightening forces and the bearing forces transmitted via the conical rings 18.1. The rest of the cylinder body 2.7 is made of a lightweight foam 19, preferably a foamed metal, and again its exterior surface is covered by a sleeve 2.5.

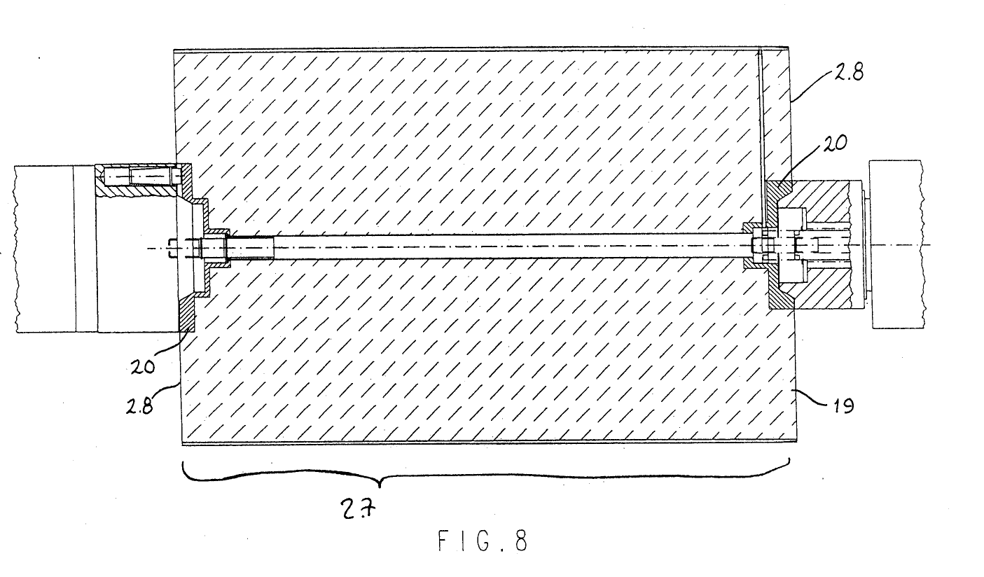

In the case of the cylinder body 2.7 according to FIG. 8, the central cylinder core has been eliminated completely, the body consisting here almost completely of a rigid foam 19, preferably metal foam, with conical disks 20 embedded in the end walls 2.8 to absorb the screw-tightening, bearing, and drive forces.

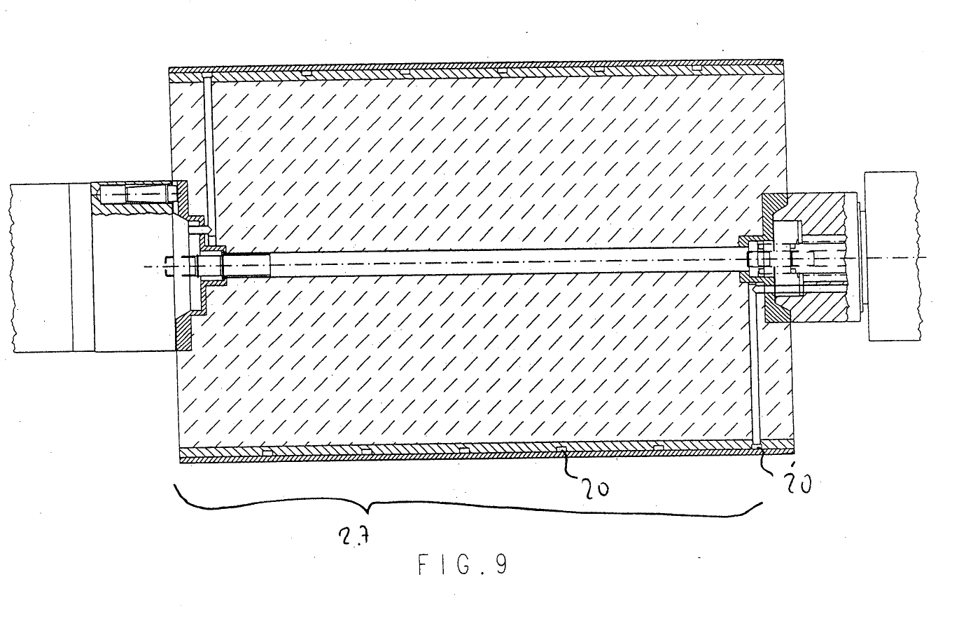

The same design is also shown in FIG. 9, except that the outer jacket has a two-piece design. This jacket comprises, for example, an inner part with spiral channels 20 for tempering the cylinder body 2.7.

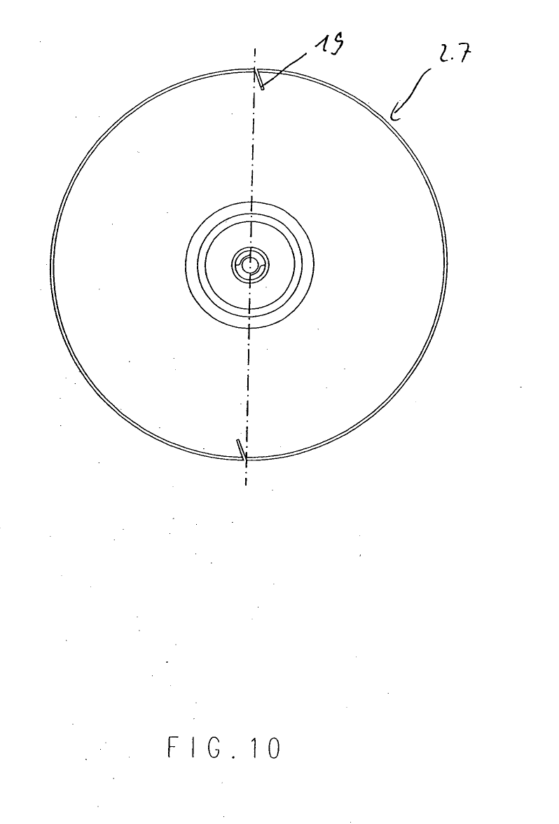

FIG. 10 shows an axial cross section through a design of a cylinder body 2.7 with slots 19 in the circumference, i.e., so-called “minigaps”, which accept the ends of the plates.

It is obvious that the features cited above and the features of the claims can be used not only in the combinations described but also in other combinations or by themselves without exceeding the scope of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A cylinder assembly for a printing press, the assembly comprising:
a pair of bearing assemblies which can be mounted in a respective pair of side frames of a printing press;
a cylinder body having a pair of opposed end surfaces and no axle stubs, each said end surface being fixed to a respective said bearing arrangement to form a connection; and
at least one locking device which can be operated from one end of the cylinder body to tighten or release the two connections.

2. The assembly of claim 1 wherein the cylinder body consists of one piece.

3. The assembly of claim 1 wherein the cylinder body comprises a core and at least one sleeve.

4. The assembly of claim 1 wherein the cylinder body comprises a foam material.

5. The assembly of claim 1 wherein the cylinder body comprises a stiffening shaft.

6. The assembly of claim 1 wherein the cylinder body has a circumferential surface provided with a coating.

7. The assembly of claim 1 wherein the cylinder body has a circumferential surface provided with at least one channel.

8. The assembly of claim 1 further comprising at least one of a conical ring and a conical disk in each said end wall.

9. The assembly of claim 1 wherein the cylinder body comprises stiffening elements extending at least one of axially and radially.

10. The assembly of claim 1 wherein the cylinder body is one of a form cylinder, a transfer cylinder, and a satellite cylinder.

11. The assembly of claim 1 wherein the cylinder body has a length which is less then 5 meters.

12. The assembly of claim 1 wherein at least one of the bearing assemblies comprises an axially adjustable spindle.
